(19) United States
(12) Patent Application Publication
(10) Pub. No.: US 2008/0141268 A1
(43) Pub. Date: Jun. 12, 2008

(54) UTILITY FUNCTION EXECUTION USING SCOUT THREADS

(76) Inventors: Partha P. Tirumalai, Fremont, CA (US); Yonghong Song, Belmont, CA (US); Spiros Kalogeropulos, Los Gatos, CA (US)

Correspondence Address: MHKKG/SUN, P.O. BOX 398, AUSTIN, TX, 78767, US

(21) Appl. No.: 11/609,682

(22) Filed: Dec. 12, 2006

(51) Int. Cl. G06F 9/46

(52) U.S. Cl. 718/107

(57) ABSTRACT

A method and mechanism for using threads in a computing system. A multithreaded computing system is configured to execute a first thread and a second thread. The first and second threads are configured to operate in a producer-consumer relationship. The second thread is configured to execute utility type functions in advance of the first thread reaching the functions in the program code. The second thread executes in parallel with the first thread and produces results from the execution which are made available for consumption by the first thread. Analysis of the program code is performed to identify such utility functions and modify the program code to support execution of the functions by the second thread.

### BACKGROUND OF THE INVENTION

1. Field of the Invention

The invention relates to computing systems and, more particularly, to multithreaded processing systems.

2. Description of the Related Art

With the widening gap between processor and memory speeds, various techniques have arisen to improve application performance. One technique utilized to attempt to improve computing performance involves using “helper” or “scout” threads. Generally speaking, a helper thread is a thread which is used to assist, or improve, the performance of a main thread. For example, a helper thread may be used to prefetch data into a cache. For example, such approaches are described in Yonghong Song, Spiros Kalogeropulos, Partha Tirumalai, “Design and Implementation of a Compiler Framework for Helper Threading on Multi-core Processors,” pp. 99-109, 14th International Conference on Parallel Architectures and Compilation Techniques (PACT'05), 2005, the content of which is incorporated herein by reference. Currently, prefetching is generally most effective for memory access streams where future memory addresses can be easily predicted—such as by using loop index values. For such access streams, software prefetch instructions may be inserted into the program to bring data into cache before the data is required. Such a prefetching scheme in which prefetches are interleaved with the main computation is also called interleaved prefetching.

Although such prefetching may be successful for many cases, it may be less effective for various types of code. For example, for code with complex array subscripts, memory access strides are often unknown at compile time. Prefetching in such code tends to incur excessive overhead as significant computation is required to compute future addresses. The complexity and overhead may also increase if the subscript evaluation involves loads that themselves must be prefetched and made speculative. One such example is an indexed array access. If the prefetched data is already in the cache, such large overheads can cause a significant slowdown. To avoid risking large penalties, modern production compilers often ignore such cases by default, or prefetch data speculatively, one or two cache lines ahead. Another example of difficult code involves pointer-chasing. In this type of code, at least one memory access is needed to get the memory address in the next loop iteration. Interleaved prefetching is generally not able to handle such cases. While a variety of approaches have been proposed to attack pointer-chasing, none have been entirely successful.

In addition to the above, it can be very difficult to parallelize single threaded program code. In such cases it may be difficult to fully utilize a multithreaded processor and processor resources may go unused.

In view of the above, effective methods and mechanisms for improving application performance using helper threads are desired.

### SUMMARY OF THE INVENTION

Methods and mechanisms for utilizing scout threads in a multithreaded computing system are contemplated.

A method is contemplated wherein a scout thread is utilized in a second core or logical processor in a multi-threaded system to improve the performance of a main thread. In one embodiment, a scout thread executes in parallel with the main thread that it attempts to accelerate. The scout and main threads are configured to operate in a producer-consumer relationship. The scout thread is configured to execute utility type functions in advance of the main thread reaching such functions in the program code. The scout thread executes in parallel with the first thread and produces results from the execution which are made available for consumption by the main thread. In one embodiment, analysis (e.g., static) of the program code is performed to identify such utility functions and modify the program code to support scout thread execution.

Responsive to the main thread detecting a call point for such a function, the main thread is configured to access a designated location for the purpose of consuming results produced by the scout thread. Also contemplated is the scout thread maintaining a status of execution of such function. Included in the status may be an identification of the function, and an indication as to whether the scout thread has produced results for a given function.

These and other embodiments, variations, and modifications will become apparent upon consideration of the following description and associated drawings.

### BRIEF DESCRIPTION OF THE DRAWINGS

FIG. 1 is a block diagram illustrating one embodiment of a multi-threaded multi-core processor.

FIG. 2 depicts one embodiment of a program sequence including functions.

FIG. 3 depicts one embodiment of a program sequence, main thread, and scout thread.

FIG. 4 depicts one embodiment of a method for utilizing scout threads.

FIG. 5 depicts one embodiment of a method for analyzing and modifying program code to support scout threads.

FIG. 6 illustrates one example of execution using a scout thread.

FIG. 7 illustrates one embodiment of work done with and without a scout thread.

FIG. 8 is a block diagram illustrating one embodiment of a computing system.

While the invention is susceptible to various modifications and alternative forms, specific embodiments are shown herein by way of example. It is to be understood that the drawings and description included herein are not intended to limit the invention to the particular forms disclosed. Rather, the intention is to cover all modifications, equivalents and alternatives falling within the spirit and scope of the present invention as defined by the appended claims.

### DETAILED DESCRIPTION

### Overview of Multithreaded Processor Architecture

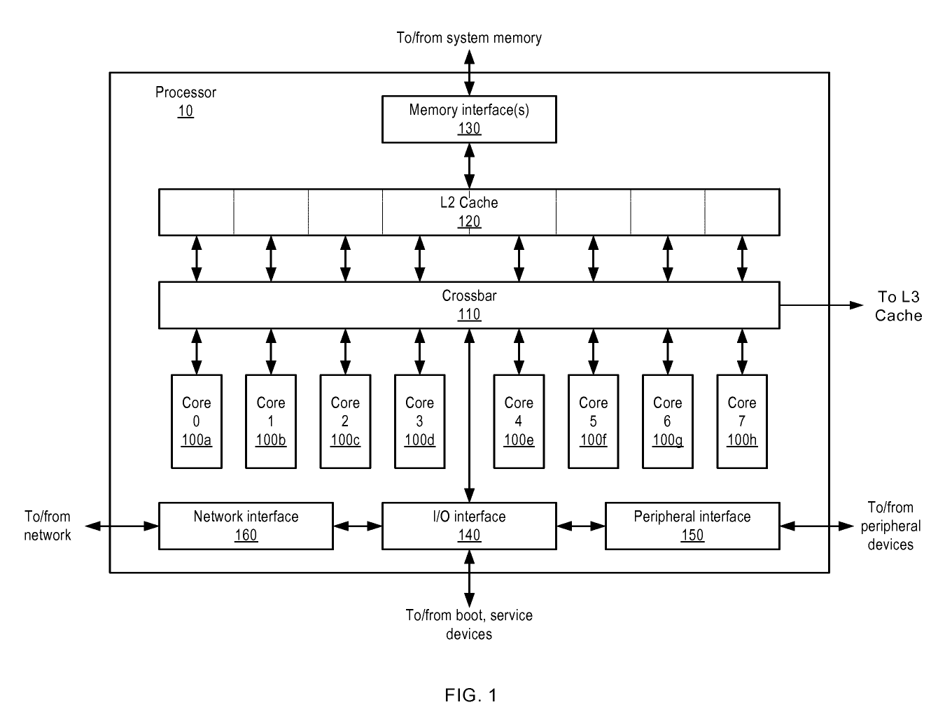

A block diagram illustrating one embodiment of a multithreaded processor 10 is shown in FIG. 1. In the illustrated embodiment, processor 10 includes a plurality of processor cores 100a-h, which are also designated “core 0” though “core 7”. Each of cores 100 is coupled to an L2 cache 120 via a crossbar 110. L2 cache 120 is coupled to one or more memory interface(s) 130, which are coupled in turn to one or more banks of system memory (not shown). Additionally, crossbar 110 couples cores 100 to input/output (I/O) interface 140, which is in turn coupled to a peripheral interface 150 and a network interface 160. As described in greater detail below, I/O interface 140, peripheral interface 150, and network interface 160 may respectively couple processor 10 to boot and/or service devices, peripheral devices, and a network.

Cores 100 may be configured to execute instructions and to process data according to a particular instruction set architecture (ISA). In one embodiment, cores 100 may be configured to implement the SPARC V9 ISA, although in other embodiments it is contemplated that any desired ISA may be employed, such as x86 compatible ISAs, PowerPC compatible ISAs, or MIPS compatible ISAs, for example. (SPARC is a registered trademark of Sun Microsystems, Inc.; PowerPC is a registered trademark of International Business Machines Corporation; MIPS is a registered trademark of MIPS Computer Systems, Inc.). In the illustrated embodiment, each of cores 100 may be configured to operate independently of the others, such that all cores 100 may execute in parallel. Additionally, in some embodiments each of cores 100 may be configured to execute multiple threads concurrently, where a given thread may include a set of instructions that may execute independently of instructions from another thread. (For example, an individual software process, such as an application, may consist of one or more threads that may be scheduled for execution by an operating system.) Such a core 100 may also be referred to as a multithreaded (MT) core. In one embodiment, each of cores 100 may be configured to concurrently execute instructions from eight threads, for a total of 64 threads concurrently executing across processor 10. However, in other embodiments it is contemplated that other numbers of cores 100 may be provided, and that cores 100 may concurrently process different numbers of threads.

Crossbar 110 may be configured to manage data flow between cores 100 and the shared L2 cache 120. In one embodiment, crossbar 110 may include logic (such as multiplexers or a switch fabric, for example) that allows any core 100 to access any bank of L2 cache 120, and that conversely allows data to be returned from any L2 bank to any of the cores 100. Crossbar 110 may be configured to concurrently process data requests from cores 100 to L2 cache 120 as well as data responses from L2 cache 120 to cores 100. In some embodiments, crossbar 110 may include logic to queue data requests and/or responses, such that requests and responses may not block other activity while waiting for service. Additionally, in one embodiment crossbar 110 may be configured to arbitrate conflicts that may occur when multiple cores 100 attempt to access a single bank of L2 cache 120 or vice versa.

L2 cache 120 may be configured to cache instructions and data for use by cores 100. In the illustrated embodiment, L2 cache 120 may be organized into eight separately addressable banks that may each be independently accessed, such that in the absence of conflicts, each bank may concurrently return data to a respective core 100. In some embodiments, each individual bank may be implemented using set-associative or direct-mapped techniques. For example, in one embodiment, L2 cache 120 may be a 4 megabyte (MB) cache, where each 512 kilobyte (KB) bank is 16-way set associative with a 64-byte line size, although other cache sizes and geometries are possible and contemplated. L2 cache 120 may be implemented in some embodiments as a writeback cache in which written (dirty) data may not be written to system memory until a corresponding cache line is evicted.

In some embodiments, L2 cache 120 may implement queues for requests arriving from and results to be sent to crossbar 110. Additionally, in some embodiments L2 cache 120 may implement a fill buffer configured to store fill data arriving from memory interface 130, a writeback buffer configured to store dirty evicted data to be written to memory, and/or a miss buffer configured to store L2 cache accesses that cannot be processed as simple cache hits (e.g., L2 cache misses, cache accesses matching older misses, accesses such as atomic operations that may require multiple cache accesses, etc.). L2 cache 120 may variously be implemented as single-ported or multiported (i.e., capable of processing multiple concurrent read and/or write accesses). In either case, L2 cache 120 may implement arbitration logic to prioritize cache access among various cache read and write requesters.

Memory interface 130 may be configured to manage the transfer of data between L2 cache 120 and system memory, for example in response to L2 fill requests and data evictions. In some embodiments, multiple instances of memory interface 130 may be implemented, with each instance configured to control a respective bank of system memory. Memory interface 130 may be configured to interface to any suitable type of system memory, such as Fully Buffered Dual Inline Memory Module (FB-DIMM), Double Data Rate or Double Data Rate 2 Synchronous Dynamic Random Access Memory (DDR/DDR2 SDRAM), or Rambus DRAM (RDRAM), for example. (Rambus and RDRAM are registered trademarks of Rambus Inc.). In some embodiments, memory interface 130 may be configured to support interfacing to multiple different types of system memory.

In the illustrated embodiment, processor 10 may also be configured to receive data from sources other than system memory. I/O interface 140 may be configured to provide a central interface for such sources to exchange data with cores 100 and/or L2 cache 120 via crossbar 110. In some embodiments, I/O interface 140 may be configured to coordinate Direct Memory Access (DMA) transfers of data between network interface 160 or peripheral interface 150 and system memory via memory interface 130. In addition to coordinating access between crossbar 110 and other interface logic, in one embodiment I/O interface 140 may be configured to couple processor 10 to external boot and/or service devices. For example, initialization and startup of processor 10 may be controlled by an external device (such as, e.g., a Field Programmable Gate Array (FPGA)) that may be configured to provide an implementation- or system-specific sequence of boot instructions and data. Such a boot sequence may, for example, coordinate reset testing, initialization of peripheral devices and initial execution of processor 10, before the boot process proceeds to load data from a disk or network device. Additionally, in some embodiments such an external device may be configured to place processor 10 in a debug, diagnostic, or other type of service mode upon request.

Peripheral interface 150 may be configured to coordinate data transfer between processor 10 and one or more peripheral devices. Such peripheral devices may include, without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 150 may implement one or more instances of an interface such as Peripheral Component Interface Express (PCI-Express), although it is contemplated that any suitable interface standard or combination of standards may be employed. For example, in some embodiments peripheral interface 150 may be configured to implement a version of Universal Serial Bus (USB) protocol or IEEE 1394 protocol in addition to or instead of PCI-Express.

Network interface 160 may be configured to coordinate data transfer between processor 10 and one or more devices (e.g., other computer systems) coupled to processor 10 via a network. In one embodiment, network interface 160 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, network interface 160 may be configured to implement multiple discrete network interface ports.

While the embodiment of FIG. 1 depicts a processor which includes eight cores, the methods and mechanisms described herein are not limited to such micro-architectures. For example, in one embodiment, a processor such as the Sun Microsystems UltraSPARC IV+ may be utilized. In one embodiment, the Ultra-SPARC IV+ processor has two on-chip cores and a shared on-chip L2 cache, and implements the 64-bit SPARC V9 instruction set architecture (ISA) with extensions. The UltraSPARC IV+ processor has two 4-issue in-order superscalar cores. Each core has its own first level (L1) instruction and data caches, both 64 KB. Each core also has its own instruction and data translation lookaside buffers (TLB's). The cores share an on-chip 2 MB level 2 (L2) unified cache. Also shared is a 32 MB off-chip dirty victim level 3 (L3) cache. The level 2 and level 3 caches can be configured to be in split or shared mode. In split mode, each core may allocate in only a portion of the cache. However, each core can read all of the cache. In shared mode, each core may allocate in all of the cache. For ease of discussion, reference may generally be made to such a two-core processor. However, it is to be understood that the methods and mechanisms described herein may be generally applicable to processors with any number of cores.

As discussed above, various approaches have been undertaken to improve application performance by using a helper thread to prefetch data for a main thread. Also discussed above, are some of the limitations of such approaches. In the following discussion, methods and mechanisms are described for better utilizing a helper thread(s). Generally speaking, it is noted that newer processor architectures may include multiple cores. However, it is not always the case that a given application executing on such a processor is able to utilize all of the processing cores in an effective manner. Consequently, one or more processing cores may be idle during execution. Given the likelihood that additional processing resources (i.e., one or more cores) will be available during execution, it may be desirable to take advantage of the one or more cores for execution of a helper thread. It is noted that while the discussion may generally refer to a single helper thread, those skilled in the art will appreciate that the methods and mechanisms described herein may include more than a single helper thread.

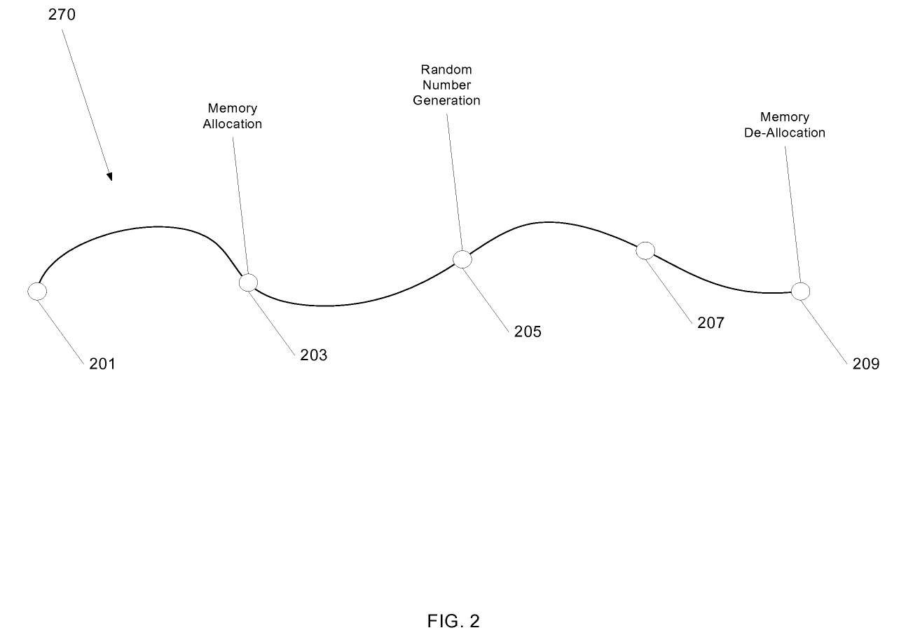

Turning now to FIG. 2, one embodiment of a serially executed thread of program code 270 is shown. Thread of code 270 may simply comprise a program code sequence. Along the thread of code are a number of portions of code (201, 203, 205, 207, and 209), including various functions and/or function calls. For example, a memory allocation call 203 (e.g., a “malloc” type call), and a memory de-allocation call 209 (e.g., a “free” type call) are shown. Also shown is a call 205 for the generation of a random number (e.g., a “drand” call). Also shown are portions of code (or calls to code) 201 and 207. Generally speaking, execution of the thread of code 270 may progress serially through code portions 201, 203, 205, 207, and 209 in that order. It is understood that branches and other conditions may alter the order, but for purposes of discussion a simple serial execution is assumed.

As may be appreciated, in a single thread 270 of execution such as that depicted in FIG. 2, extracting parallelism can be very difficult. Attempting to execute some given portion of code, such as code 207, in parallel with other portions of the thread 270 may be difficult given that the given portion of code 207 may depend upon previously computed values of the thread 270. For example, inputs to code 207 may be determined by the output of earlier occurring code. Therefore, in one embodiment, program code such as that depicted in FIG. 2 may be parallelized by identifying particular types of code which don't have, or are less likely to have, dependencies on earlier code such as that described above.

In one embodiment, various utility type functions or code portions are identified as candidates for parallel execution. Generally speaking, utility functions may comprise functions which are not directly related to computation, or are otherwise known to have no dependencies on other code. For example, FIG. 2 shows functions which are in the critical path of execution which are not directly related to the computation of the thread 270. The memory allocation 203 and de-allocation functions 209 are not directly related to the computation. Additionally, the random number generation 205 may have no dependence on other code. Therefore, these portions of utility type code are candidates for parallelization. It is further noted that because these functions (203, 205, 209) are in the critical path, their execution does impact execution time of the thread 270. Therefore, if these functions can be executed in parallel with other portions of the thread 270, then overall execution time of the thread 270 may be reduced.

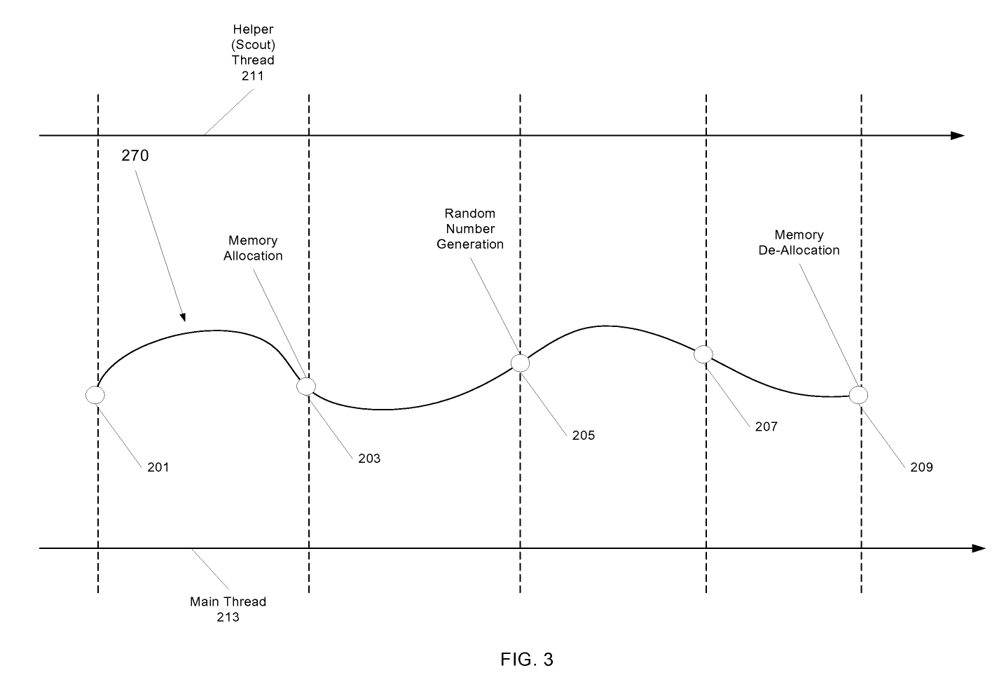

FIG. 3 illustrates an embodiment where a helper (or “scout”) thread is utilized in the parallelization of a thread of code. In the embodiment shown, the thread 270 of FIG. 2 is again shown. Like items in FIG. 3 are numbered the same as those of FIG. 2. In the embodiment shown, a main thread 213 is shown which is configured to execute the thread 270. As part of a parallelization of the thread 270, utility type functions (203, 205) have been selected for execution by a scout thread 211. In one embodiment, each of the main thread 213 and scout thread 211 are capable of concurrent execution. For example, in a multithreaded processor, hardware for supporting concurrent threads of execution may be present.

In one embodiment, scout thread 211 is configured to execute functions 203 and 205 in the thread 270 prior to the time the main thread 213 reaches those functions during execution of the thread 270. In one embodiment, scout thread 211 and main thread 213 may be configured in a producer-consumer relationship. In such a relationship, scout thread 211 is configured to produce data for consumption by the main thread 213. In such an embodiment, when the main thread 213 reaches a particular function which has been designated as one which is to be executed by scout thread 211, the main thread 213 may access an identified location for retrieval of data produced (“results”) by the scout thread 211. If the required data has been produced and is valid, the main thread 213 may utilize the previously generated results and continue execution without the need to execute the particular function and incur the execution latency which would ordinarily be incurred. In this manner, some degree of parallelization may be successfully achieved and overall execution time reduced.

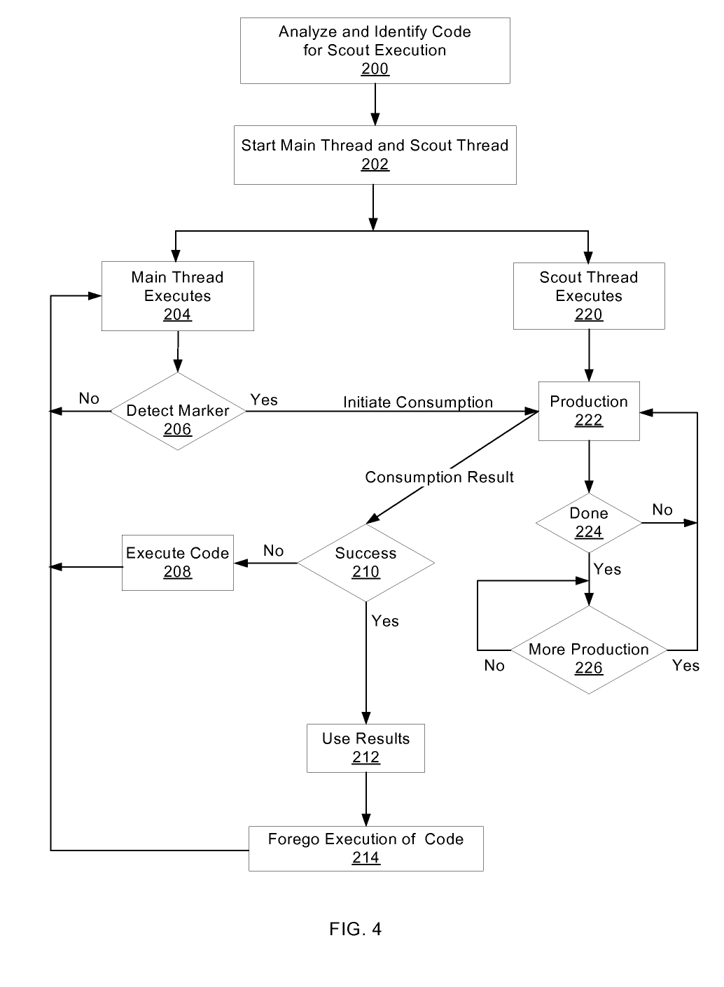

Turning now to FIG. 4, one embodiment of a method for utilizing scout threads in the parallelization of program code. Generally speaking, scout threads may be utilized to execute selected instructions in an anticipatory manner in order to accelerate performance of another thread (e.g., a main thread). Generally speaking, a main thread may itself spawn one or more scout threads which then perform tasks on behalf of the main thread. In one embodiment, the scout thread may share the same address space as the main thread.

In the example shown, an initial analysis of the application code may be performed (block 200). In one embodiment, this analysis may generally be performed during compilation, though such analysis may be performed at other times as well. During analysis, selected portions of code are identified which may be executed by a scout thread during execution of the application. Such portions of code may comprise entire functions (functions, methods, procedures, etc.), portions of individual functions, multiple functions, or other instructions sequences. In one embodiment, the identified portions of code correspond to utility type functions such as memory allocations which are not directly related to computation. Subsequent to identifying such portions of code, the application code may be modified to include some type of indication or marker that the code has been designated as code to be executed by the (a) scout thread. It is noted that while the term “thread” is generally used herein, a thread may refer to any of a variety of executable processes and is not intended to be limited to any particular type of process. Further, while multi-processing is described herein, other embodiments may perform multi-threading on a time-sliced basis or otherwise. All such embodiments are contemplated.

After modification of the code to support the scout thread(s), the application may be executed and both a main thread and a scout thread may be launched (block 202). As depicted, both the main thread 204 and scout thread 220 may begin execution. As the scout thread does not generally have any dependence on data produced by the main thread, the scout thread may begin executing the functions designated for it and producing results (block 222). This production on the part of the scout thread may continue until done (decision block 224) and/or until more production is requested (decision block 226). In one embodiment, results produced by the scout thread may be stored in a shared buffer area accessible by the main thread. In addition, the scout thread may maintain a status of its execution and production. Such status may also be stored in a shared buffer area.

Whether and how much a scout thread produces may be predetermined, or determined dynamically in dependence on a current state of processing. For example, if a program sequence utilizes a call to generate a random number, the scout thread may be configured to maintain at least a predetermined number (e.g., five) of pre-computed random numbers available for consumption by the main thread at all times. The main thread may then simply read the values that have already been generated by the scout. If the available number falls below this predetermined number, then the scout thread may automatically produce more random numbers. Alternatively, the predetermined number itself may vary with program conditions. For example, if particular program sequence is being executed with a given frequency, then the predetermined number may be dynamically increased or decreased as desired. Numerous such alternatives are possible and are contemplated.

During continued execution of the main thread (block 205), the previously marked portion of code may be reached. For example, as in the discussion above, a previously identified function call may be reached by the main thread which has been marked as code to be executed by a scout thread. Responsive to detecting this marker (decision block 206), the main thread may initiate consumption of results produced by the scout thread. For convenience, the shared memory location is depicted as production block 222. In one embodiment, initiating consumption comprises accessing the above described shared memory location. Based upon such an access, a determination may be made as to whether the consumption is successful (decision block 210). For example, the scout thread may be responsible for allocating portions of memory for use by the main thread. Having allocated a portion of memory, the scout thread may store a pointer to the allocated memory in the shared memory area. Other identifying indicia may be stored therein as well, such as an indication that a particular pointer corresponds to a particular function call and/or marker encountered by the main thread. Other status information may be stored as well, such as an indication that there are no production results currently available, etc. Any such desirable status or identifying information may be included therein.

If in decision block 210 it is determined that the consumption is successful, the main thread may use the results obtained via consumption (block 212) and forego execution of the function that would otherwise need to be executed in the absence of the scout thread. If however, the consumption is not successful (decision block 210), then the main thread may execute the function/code itself (block 208) and proceed (block 204). It is noted that determining whether a particular consumption is successful may comprise more than simply determining whether there are results available for consumption. For example, a scout thread may be configured to allocate chunks of memory of a particular size (e.g., 256 bytes). However, at the time of consumption, the main thread may require a larger portion of memory. In such a case, the consumption may be deemed to have failed. Should consumption fail, shared memory area may comprise a call to the function code executable by the main thread. In this manner, the main thread may execute the particular code (e.g., memory allocation) when needed.

In various embodiments, a function which has been identified for possible execution by a scout thread may be duplicated. In this manner, the scout thread may have its own copy of the code to be executed. Various approaches to identifying such code portions are possible. For example, if a candidate function has a call point at a code offset of 0x100, then this offset may be used to identify the code. A corresponding marker may then be inserted in the code which includes this identifier (i.e., 0x100). Alternatively, any type of mapping or aliasing may be used for identifying the location of such portions of code. A status which is maintained by the scout thread in a shared memory location may then also include such an identifier. A simple example of a status which may be maintained for a function malloc( ) is shown in TABLE 1 below.

TABLE 1

| Variable | Value | Description |
|---|---|---|
| ID | 0x100 | An identifier for the portion of code |
| | | (e.g., a “malloc”) |
| Status | Available | Thread status for this portion of code |
| | | (e.g., Results are available/unavailable) |
| Outputs | | A list of the results/outputs of the computation |
| Result1 | pointer | e.g., a pointer to an allocated portion of memory |
| Result2 | pointer | |
| Result3 | pointer | |
| Result4 | null | |

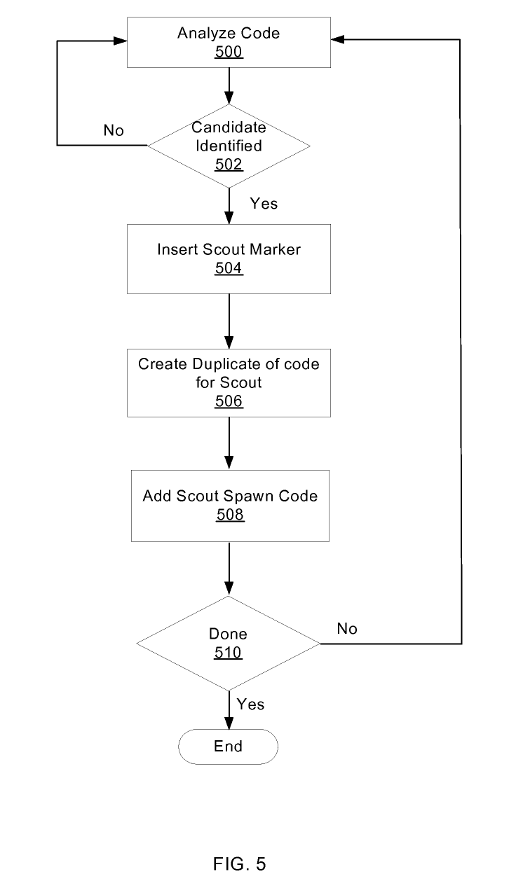

FIG. 5 shows one embodiment of a method for analyzing and modifying program code to support scout threads. In the embodiment shown, an analysis of the program code is performed (block 500). Such analysis may, for example, be performed at compile time. During such analysis, utility type functions may be identified as candidates for execution by a scout thread. In an embodiment wherein utility type functions are being identified, the need to know precise program flow and behavior is reduced. If such a candidate is identified (decision block 502), then the program code may be modified by adding a marker that indicates the code is to be executed by a scout thread. Such a marker may serve to inform the main thread that it is to initiate a consumption action directed to some identified location.

In addition, a duplicate of the candidate code may be generated for execution by a scout thread. In this manner, the scout thread would have its own separate copy of the code. Further, program code to spawn a corresponding scout thread may be added to the program code as well. Spawning of the scout thread may be performed at the beginning of the program or later as desired. Finally, the process may continue until done (decision block 510).

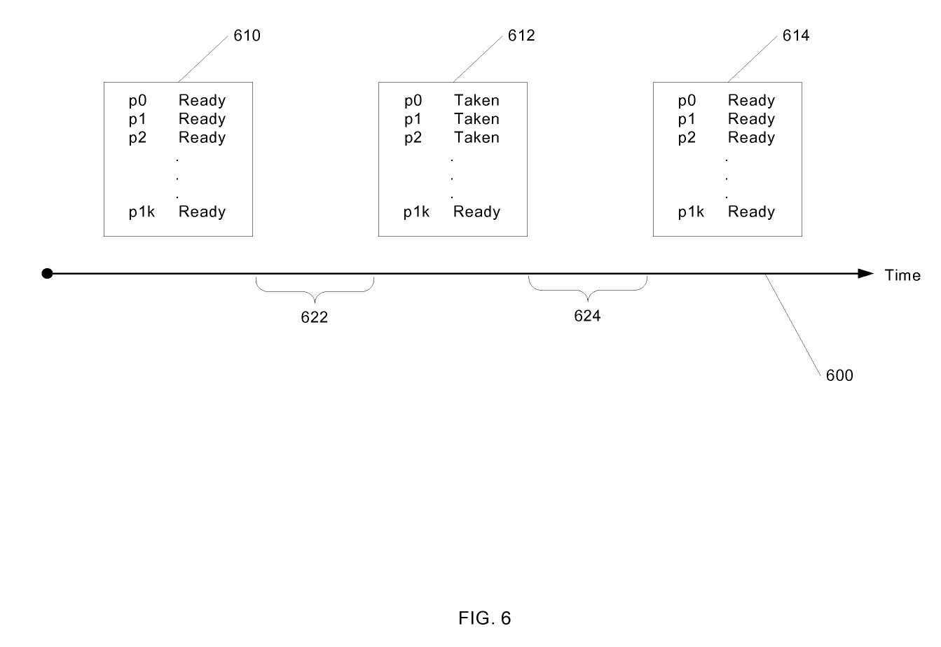

Turning now to FIG. 6, an illustration is provided which depicts the relationship between a scout and main thread. In the figure, a timeline 600 is shown which generally depicts a progression of time from left to right. During this time, a scout thread is configured to allocate memory for use by the main thread. In the example shown, the scout thread may initially allocate one thousand chunks of memory and corresponding pointers (p0-plk) to the allocated chunks as shown in block 610. As shown in block 610, each of the pointers is ready (“Ready”) for use by the main thread. In one embodiment, each of the pointers p0-plk may be stored in a buffer accessible by the main thread. During a following period of time 622, the main thread may retrieve a number of the pointers for use as needed. Consequently, at a subsequent point in time (block 612), some of the pointers are shown to have been utilized (“Taken”).

As pointers are utilized by the main thread, the scout thread may allocate more memory and refill the buffer with corresponding pointers. The decision as to if and when the scout may allocate new memory may be based on any algorithm or rule desired. For example, the scout may be configured to allocate more memory when the number of entries in the buffer falls between a particular threshold. Alternatively, the scout may allocate more memory on a periodic basis. Numerous such alternatives are possible and are contemplated. In the example of FIG. 6, during a period of time 624, the scout “refills” the buffer 614 with pointers to newly allocated chunks of memory.

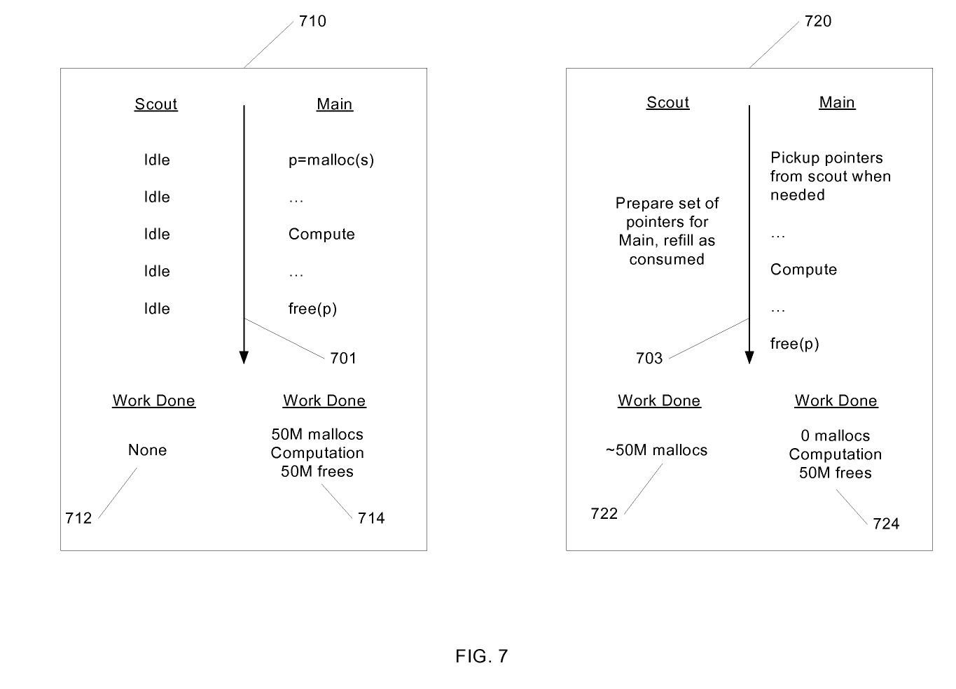

Utilizing an approach such as that described above, work may be removed from the critical path of execution. FIG. 7 illustrates a first scenario 710 in which a scout thread is not utilized, and a second scenario 720 in which a scout thread is utilized. Assume for purposes of discussion that a particular series of computations requires 50 million (50 M) allocations (e.g., mallocs) of memory and de-allocations (e.g., frees) of memory. Block 710 illustrates activities performed by a scout thread to the left of a time line 701, and activities performed by a main thread to the right of the time line 701. In the example shown, the main thread performs a sequence of actions which includes the allocation of memory (“p=mallac( )”), some computation, and the de-allocation of memory (“free(p)”).

Assuming the sequence is performed 50 M times, work 714 performed by the main thread includes 50 M mallocs, computation, and 50 M frees. All of this work 714 of the main thread may be in the critical path of execution. In this scenario 710, the scout thread is idle and does no work 712.

Scenario 720 of FIG. 7 depicts a case wherein a scout thread is utilized. As before, activities performed by a scout thread are to the left of a time line 703, and activities performed by a main thread are to the right of the time line 703. Assume a code sequence in which the main thread performs the same activities as those of scenario 710. However, in this scenario 720, the scout thread takes responsibility for allocating memory needed by the main thread. Therefore, in this scenario 720, the scout thread allocates memory and prepares corresponding sets of pointers for use by the main thread. Additionally, the scout thread may be configured to allocate more memory as needed. The main thread then does not generally need to allocate memory (malloc). Rather, the main thread simply obtains pointers to memory already allocated by the scout thread. The main thread may the proceed to utilize the memory as desired and de-allocate (free) the utilized memory as appropriate. Using this approach 720, work 722 done by the scout thread includes ˜50 M mallocs. Work 724 done by the main thread includes 0 mallocs, computation, and 50 M frees. Accordingly, 50 M allocations of memory are not performed by the main thread and have been removed from the critical path of execution. In this manner, performance of the processing performed by the main thread may be improved.

### Exemplary System Embodiment

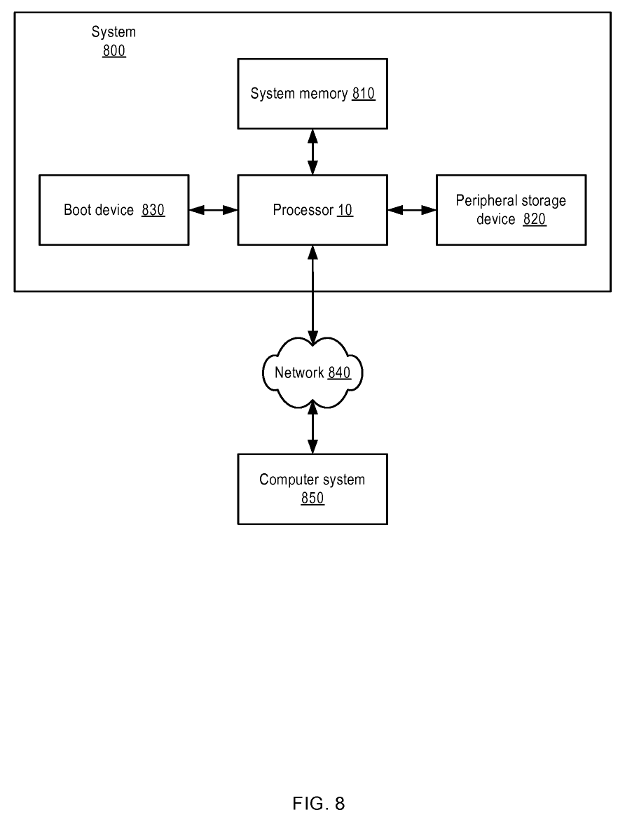

As described above, in some embodiments processor 10 of FIG. 1 may be configured to interface with a number of external devices. One embodiment of a system including processor 10 is illustrated in FIG. 8. In the illustrated embodiment, system 800 includes an instance of processor 10 coupled to a system memory 810, a peripheral storage device 820 and a boot device 830. System 800 is coupled to a network 840, which is in turn coupled to another computer system 850. In some embodiments, system 800 may include more than one instance of the devices shown, such as more than one processor 10, for example. In various embodiments, system 800 may be configured as a rack-mountable server system, a standalone system, or in any other suitable form factor. In some embodiments, system 800 may be configured as a client system rather than a server system.

In various embodiments, system memory 810 may comprise any suitable type of system memory as described above, such as FB-DIMM, DDR/DDR2 SDRAM, or RDRAM®, for example. System memory 810 may include multiple discrete banks of memory controlled by discrete memory interfaces in embodiments of processor 10 configured to provide multiple memory interfaces 130. Also, in some embodiments system memory 810 may include multiple different types of memory.

Peripheral storage device 820, in various embodiments, may include support for magnetic, optical, or solid-state storage media such as hard drives, optical disks, nonvolatile RAM devices, etc. In some embodiments, peripheral storage device 820 may include more complex storage devices such as disk arrays or storage area networks (SANs), which may be coupled to processor 10 via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processor 10, such as multimedia devices, graphics/display devices, standard input/output devices, etc.

As described previously, in one embodiment boot device 830 may include a device such as an FPGA or ASIC configured to coordinate initialization and boot of processor 10, such as from a power-on reset state. Additionally, in some embodiments boot device 830 may include a secondary computer system configured to allow access to administrative functions such as debug or test modes of processor 10.

Network 840 may include any suitable devices, media and/or protocol for interconnecting computer systems, such as wired or wireless Ethernet, for example. In various embodiments, network 840 may include local area networks (LANs), wide area networks (WANs), telecommunication networks, or other suitable types of networks. In some embodiments, computer system 850 may be similar to or identical in configuration to illustrated system 800, whereas in other embodiments, computer system 850 may be substantially differently configured. For example, computer system 850 may be a server system, a processor-based client system, a stateless “thin” client system, a mobile device, etc.

It is noted that the above described embodiments may comprise software. In such an embodiment, the program instructions which implement the methods and/or mechanisms may be conveyed or stored on a computer accessible medium. Numerous types of media which are configured to store program instructions are available and include hard disks, floppy disks, CD-ROM, DVD, flash memory, programmable ROMs (PROM), random access memory (RAM), and various other forms of volatile or non-volatile storage. Still other forms of media configured to convey program instructions for access by a computing device include terrestrial and non-terrestrial communication links such as network, wireless, and satellite links on which electrical, electromagnetic, optical, or digital signals may be conveyed. Thus, various embodiments may further include receiving, sending or storing instructions and/or data implemented in accordance with the foregoing description upon a computer accessible medium.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for using threads in executable code, the method comprising:
concurrently executing a first thread and a second thread;
the second thread producing results by executing a function in a program sequence prior to the first thread reaching a point in the program sequence which includes the function; and
the first thread reaching said point in the program sequence, and consuming said results in lieu of executing said function.

2. The method as recited in claim 1, further comprising the first thread executing said function, in response to determining valid results corresponding to said function are not available.

3. The method as recited in claim 1, further comprising the second thread storing said results in a memory location shared by both the first thread and the second thread.

4. The method as recited in claim 1, further comprising analyzing said executable code and modifying the executable code to include an indication that said function is to be executed by the second thread.

5. The method as recited in claim 4, further comprising modifying said executable code to add instructions which create the second thread.

6. The method as recited in claim 1, wherein the function comprises a utility type function.

7. The method as recited in claim 6, wherein said utility type function is in a critical path of the program sequence.

8. A multithreaded multicore processor comprising:
a memory; and
a plurality of processing cores, wherein a first core of said cores is configured to execute a first thread, and a second core of said cores is configured to execute a second thread, wherein the first thread and second thread are concurrently executable;
wherein the second thread is configured to produce results by executing a function in a program sequence prior to the first thread reaching a point in the program sequence which includes the function; and
wherein the first thread is configured to consume said results in lieu of executing said function, in response to reaching said point in the program sequence.

9. The processor as recited in claim 8, wherein the first thread is further configured to execute said function, in response to determining valid results corresponding to said function are not available.

10. The processor as recited in claim 8, wherein the second thread is further configured to store said results in a memory location of the memory shared by both the first thread and the second thread.

11. The processor as recited in claim 8, wherein the second thread is configured to execute a duplicate of said function.

12. The processor as recited in claim 8, wherein the function comprises a utility type function.

13. The processor as recited in claim 12, wherein said utility type function is in a critical path of the program sequence.

14. A computer readable medium comprising program instructions, said program instructions being operable to cause:
concurrent execution of a first thread and a second thread;
the second thread to produce results by executing a function in a program sequence prior to the first thread reaching a point in the program sequence which includes the function; and
the first thread to consume said results in lieu of executing said function, in response to reaching said point in the program sequence.

15. The medium as recited in claim 14, wherein said program instructions are further operable to cause the first thread to execute said function, in response to determining valid results corresponding to said function are not available.

16. The medium as recited in claim 14, wherein said program instructions are further operable to cause the second thread to store said results in a memory location shared by both the first thread and the second thread.

17. The medium as recited in claim 14, wherein said program instructions are further operable to analyze said executable code and modify the executable code to include an indication that said function is to be executed by the second thread.

18. The medium as recited in claim 17, wherein said program instructions are further operable to modify said executable code to add instructions which create the second thread.

19. The medium as recited in claim 14, wherein the function comprises a utility type function.

20. The medium as recited in claim 19, wherein said utility type function is in a critical path of the program sequence.
